(19) United States
(12) Patent Application Publication
(10) Pub. No.: US 2013/0155824 A1
(43) Pub. Date: Jun. 20, 2013

(54) OPTICAL DISC DEVICE AND OPTICAL DISC RECORDING METHOD

(71) Applicant: HITACHI CONSUMER ELECTRONICS CO., LTD., Tokyo (JP)

(72) Inventor: Tomomi OKAMOTO, Yokohama (JP)

(73) Assignee: HITACHI CONSUMER ELECTRONICS CO., LTD., Tokyo (JP)

(21) Appl. No.: 13/711,252

(22) Filed: Dec. 11, 2012

(30) Foreign Application Priority Data
Dec. 14, 2011 (JP) 2011-272916

(51) Int. Cl. G11B 7/007

(52) U.S. Cl. CPC G11B 7/007
USPC 369/30.03

(57) ABSTRACT

On the occasion of providing a guard track and additionally recording data in an optical disc provided with a guide layer having a physical groove structure for carrying out tracking servo control and not having a land/groove structure in recording layers carrying out recording and playback, it has sometimes occurred that it was difficult to reposition a light spot. Given that there are a recorded area and an unrecorded area in a recording layer, recording with respect to the concerned recording layer is taken to be impossible to implement when the recording capacity of the unrecorded area is less than a prescribed value.

### INCORPORATION BY REFERENCE

The present application claims priority from Japanese applications JP2011-272916 filed on Dec. 14 2011, the content of which is hereby incorporated by reference into this application.

### BACKGROUND OF THE INVENTION

1. Field of the Invention

The present invention pertains to an optical disc device that, using a laser, plays back information from an optical disc or records information on an optical disc, and a method of recording onto an optical disc.

2. Description of the Related Art

In recent years, as far as optical discs of the Bluray Disc™ Standard are concerned, there have been developed optical discs having three or four recording layers in order to increase the recording capacity. From now on, it is considered to carry out recording and playback on optical discs having a higher number of recording layers as a method of implementing further increases in capacity.

E.g., in JP-A-2008-97694, there is disclosed an optical disc (below referred to as a “grooveless optical disc”) according to a scheme in which a layer (below referred to as a “guide layer”) having a physical groove structure for carrying out tracking servo control is provided and multiple recording layers are stacked without creating a land/groove structure in the layers carrying out recording and playback (below referred to as “recording layers”), manufacturing thereof being taken to be easy even in the case where multiple recording layers are stacked.

Also in the case of carrying out recording using a guide layer and a recording layer, there are JP-A-2010-40093 and JP-A-2009-140552 as methods of providing an area e.g. called a guard track with respect to the existing recording track and carrying out additional data recordings. Specifically, in JP-A-2010-40093 and JP-A-2009-140552, in the case of carrying out recording using a guide layer and a recording layer, a previous recording area and an additional recording area are separated and overwriting is prevented by providing an area called e.g. a “guard track” with respect to the previous recording track.

### SUMMARY OF THE INVENTION

As one problem arising on the occasion of recording and playing back a grooveless disc such as mentioned above, there can be cited the problem that a positional misalignment is produced between the guide layer and the recording layer if there occurs a tilt in the optical disc, E.g., as shown in FIG. 6A, in the case of carrying out an additional recording on a disc that has been recorded once, there arises a tilt in the disc due to temperature changes and the like, as shown in FIG. 5, so, with respect to the state of the previous recording time, the tilt of the disc has changed and a positional misalignment occurs. In the case of carrying out an addition on the basis of the information of the guide layer without taking into consideration this tilt, there has been the possibility, as shown in FIG. 6B, that there occur areas in which there is an overwrite of a previous recording track and the recorded data end up being destroyed. Incidentally, in the case of playing back a grooveless disc, a tracking error signal is generated by means of the DPD (Differential Phase Detection) method or the like and there is carried out tracking control in the previously recorded data. In this case, if there are unrecorded portions, the tracking cannot be controlled since it is not possible to generate a tracking error signal.

E.g., in the aforementioned reference JP-A-2009-140552, since the guard track part is in an unrecorded state, tracking control is temporarily turned off before the guard track in the case of attempting to continuously generating a previously recorded area and an additional recording area, and the light spot is moved by just the distance corresponding to the guard track, so there is a need, all over again, to turn on tracking control, play back the addresses, and effectuate repositioning. If, at this point, the scope of the previously recorded area of the destination of movement is narrow, it becomes difficult to reposition the light spot. On the occasion of jumping across the guard tracks to move the light spot, it is necessary to move the optical system by means of an actuator such as a stepping motor, but the accuracy thereof is on the order of hundred microns. As against this, in the case of the Blu-ray Disc™ Standard, the track pitch is 0.32 microns, and if only some one hundred tracks are recorded, the width of the previously recorded area works out to 32 microns, so light spot positioning based on a stepping motor becomes difficult, Also, since there is a misalignment (eccentricity), in the optical disc, between the axis of rotation and the optical disc center, positioning to a narrow previously recorded area becomes even more difficult.

The present invention has for an object to furnish an optical disc device that, for a grooveless disc, safely positions light spots with respect to a recorded area recorded on account of an addition of data.

The aforementioned problem is improved upon by the invention according to the patent claims. As an example, it is e.g. attained, in an optical disc device having a first optical system that, with respect to an optical disc formed by being provided with a guide layer having a physical groove structure for carrying out tracking servo control and stacking recording layers carrying out recording and playback, focuses a light beam on the guide layer and detects reflected light therefrom; and a second optical system that focuses a light beam on a recording layer and detects reflected light therefrom. there being a recorded area and an unrecorded area in the recording layer, by taking an additional data recording by the second optical system to be possible to implement in the case where the recording capacity of the unrecorded area is equal to or greater than a prescribed threshold value, and taking an additional data recording with respect to the concerned recording layer to be impossible to implement when it is less than the threshold value.

According to the present invention, it becomes possible to safely position light spots with respect to a recording area in which data have been recorded additionally, for a grooveless disc.

Other objects, features, and advantages of the present invention will become apparent from the following description of embodiments of the present invention provided in relation to the accompanying drawings.

### BRIEF DESCRIPTION OF THE DRAWINGS

FIG. 1 is a diagram showing a disc in which a recorded area and an unrecorded area coexist on a grooveless disc in the present embodiment.

FIG. 2 is a diagram showing a disc, in the present embodiment, in which a guard track is provided and data have been additionally recorded behind the recorded area.

FIG. 3 is a block diagram of an optical disc device in the present embodiment

FIG. 4 is a diagram showing the case where light beams are irradiated on a guide layer and a recording layer with a first optical system and a second optical system, in the present embodiment.

FIG. 5 is a diagram explaining the positional misalignment of the light spots on the occasion where disc tilt has occurred in a grooveless disc.

FIGS. 6A and 6B are diagrams describing the state at the time when a recording has additionally been made in a state where disc tilt has occurred, in a grooveless disc.

### DESCRIPTION OF THE EMBODIMENT

Hereinafter, an embodiment o he present invention will be described based on the drawings.

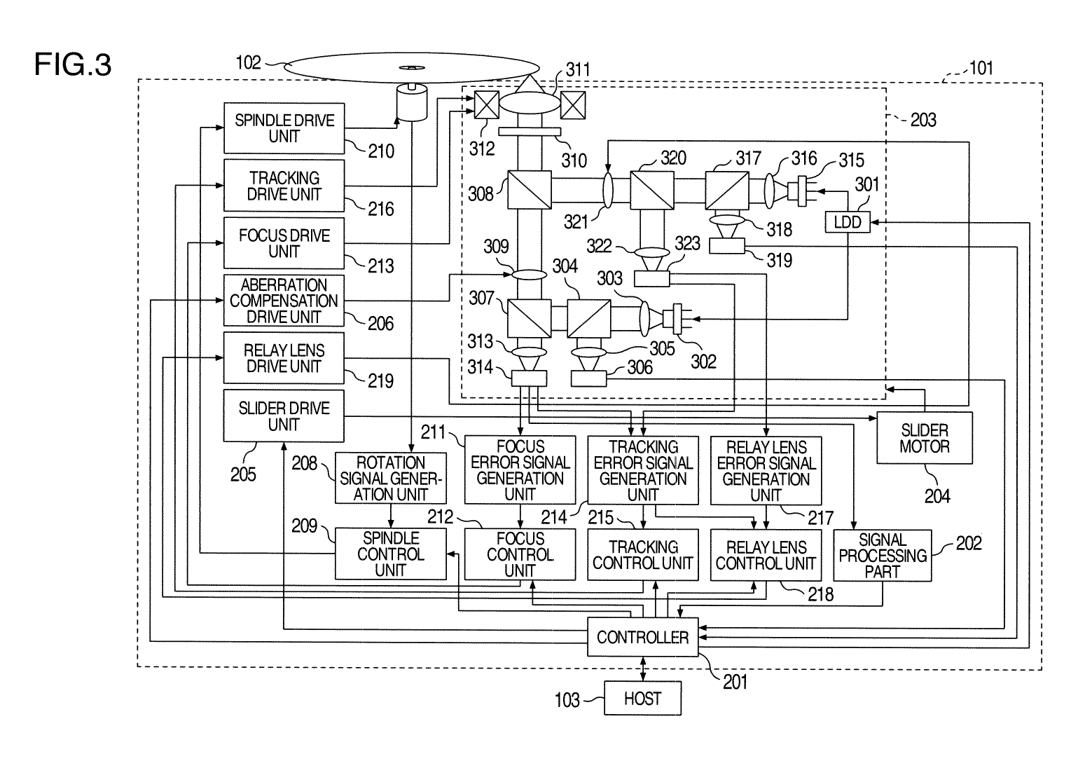

FIG. 3 is a block diagram of an embodiment of an optical disc device in accordance with the present invention. An optical disc device 101, by irradiating a laser beam on an optical disc 102 mounted in the device, carries out recording or playback of information and carries out communication, via an interface such as SATA (Serial Advanced Technology Attachment), with a host 103 such as a PC (Personal Computer).

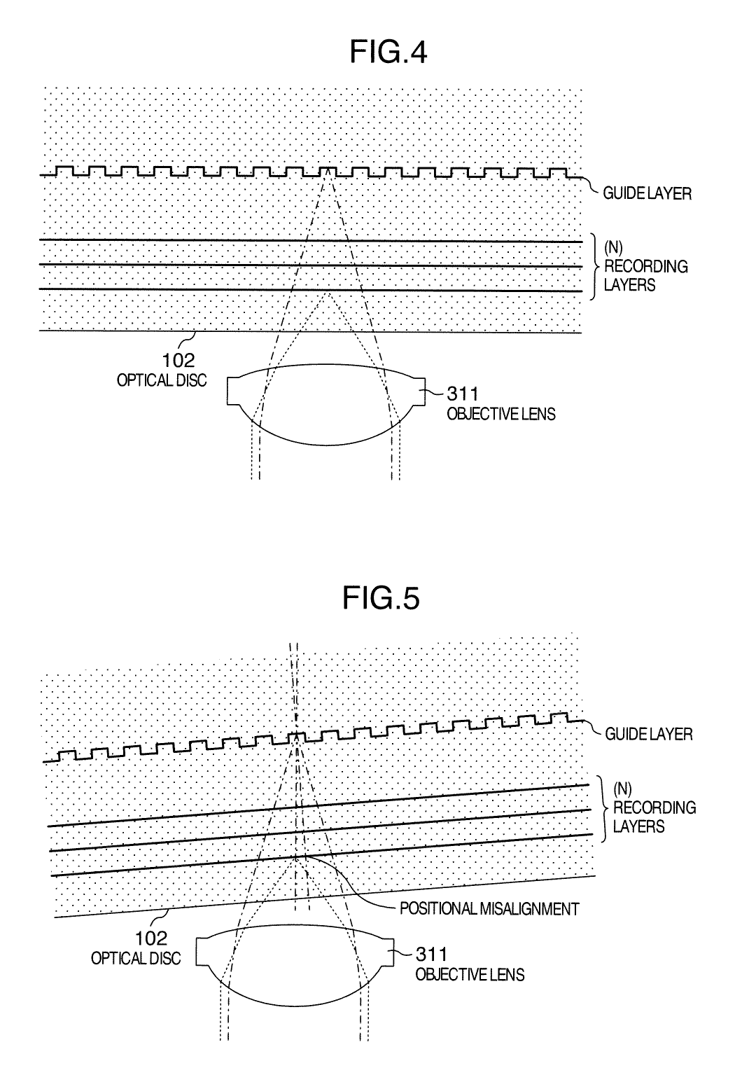

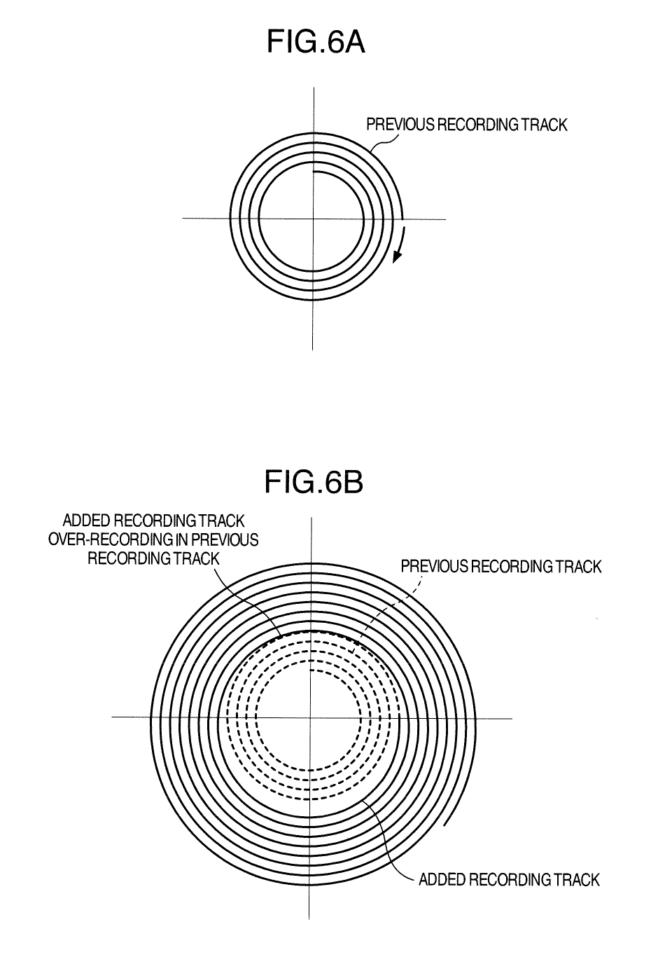

The structure of optical disc 102 is illustrated by example in FIG. 4. Optical disc 102 has a guide layer having a track (guide groove) structure and N (N≧1, N being a natural number) recording layers not having a track structure. Optical disc device 101 is able to generate laser spots in the recording layers and the guide layer by means of an objective lens 311.

In FIG. 3, optical disc device 101 comprises: a controller 201; a signal processing part 202; an optical pickup 203; a slider motor 204 moving optical pickup 203 in a radial direction of optical disc 102; a slider drive unit 205 driving slider motor 204; an aberration compensation drive unit 206 for driving a spherical aberration compensation element 309 provided inside optical pickup 203; a spindle motor 207 for rotating optical disc 102; a rotation signal generation unit 208 generating a signal synchronized with the rotation of spindle motor 207; a spindle control unit 209 generating a rotation signal for making spindle motor 207 rotate; a spindle drive unit 210 driving spindle motor 207 in response to the rotation signal generated by a spindle control unit 209; a focus error signal generation unit 211 generating a focus error signal indicating the amount of misalignment between the recording layers of optical disc 102 and the focus position of a laser spot; a focus control unit 212 generating a focus drive signal in response to a focus error signal; a focus drive unit 213 driving an actuator 312 provided inside optical pickup 203, in response to the focus drive signal; a tracking error signal generation unit 214 generating a tracking error signal indicating the positional misalignment between tracks of optical disc 102 and the laser spot; a tracking control unit 215 generating a tracking drive signal in response to the tracking error signal; a tracking drive unit 216 driving actuator 312 in response to the tracking drive signal; a relay lens error signal generation unit 217 generating a relay lens error signal indicating the amount of misalignment between the guide layer of optical disc 102 and the focal point position of the laser spot; a relay lens control unit 218 generating a relay lens drive signal in response to the relay lens error signal; and a relay lens drive unit 219 driving a relay lens 321 in response to the relay lens drive signal. Here, a stepping motor is used as spindle motor 204.

Optical pickup 203 comprises two optical systems with different wavelengths such as e.g. 405 nm and 650 nm. First, a description will be given regarding the 405 nm optical system during playback. A laser driver 301 is controlled by controller 201 and outputs a current driving a laser diode 302. As for this drive current, a radio frequency weighting of several hundred MHz is impressed in order to suppress the laser noise. Laser diode 302 emits laser light with a wavelength of 405 nm having a waveform corresponding to the drive current. The emitted laser light becomes parallel light in a collimator lens 303, a part thereof being reflected in a beam splitter 304 and condensed in a power monitor 306 by means of a condensing lens 305. Power monitor 306 feeds back a current or voltage, corresponding to the intensity of the laser light, to controller 201. In this way, the intensity of the laser light collected on the recording layers of optical disc 102 is maintained at a desired value, such as e.g. 2 mW, On the other hand, the laser light transmitted through beam splitter 304 is reflected in a polarizing beam splitter 307 and convergence and divergence are controlled by means of spherical aberration compensation element 309 driven by an error signal compensation drive unit 206. The laser light transmitted through spherical aberration compensation element 309, after being transmitted through a dichroic mirror 308, becomes circularly polarized light in a quarter-wave plate 310 and is collected on the recording layers of optical disc 102 by means of an objective lens 311. This dichroic mirror 308 is an optical element that reflects light having a specified wavelength and transmits light having other wavelengths. Here, it is taken to be one that transmits light with a wavelength of 405 nm and reflects 650-nm light. Objective lens 311 is positionally controlled by means of actuator 312. The laser light reflected by optical disc 102 is modulated in intensity in response to information recorded in optical disc 102. It becomes linearly polarized light in quarter-wave plate 310 and is transmitted, via dichroic mirror 308 and spherical aberration compensation element 309, through polarizing beam splitter 307. The transmitted laser light is collected on a detector 314 by means of a condensing lens 313. Detector 314 detects the intensity of the laser light and outputs a signal corresponding hereto to signal processing part 202. Signal processing part 202 carries out processing such as amplification, equalization, and decoding with respect to the playback signal output from detector 314 and outputs the decoded data to controller 201. Controller 201 outputs the data to host 103.

Also, a focus error signal generation unit 211 generates a focus error signal with respect to the recording layers, from the signal output from detector 314. By means of a command signal from controller 201, a focus control unit 212 outputs a focus drive signal corresponding to the focus error signal to a focus drive unit 213. The focus drive unit 213, in response to the focus drive signal, drives actuator 312 in a direction perpendicular to the disc surface. As mentioned above, due to the fact that the focus control unit 212 and the focus drive unit 213 operate, focus control is carried out so that the laser spot irradiated on a recording layer of optical disc 102 is continually focused on the recording layer.

On the occasion of carrying out recording, recording data are input from host 103 to controller 201. Controller 201 outputs a recording waveform corresponding to the input data to laser driver 301. Laser driver 301 outputs a drive current corresponding to the recording waveform to laser diode 302 and recording is carried out in a recording layer of optical disc 102 by irradiating laser light with a waveform handled by laser diode 302.

Next, there will be given a description regarding the 650-nm optical system. Regarding the present optical system, there is no difference in operation during recording and during playback. In the same way as the 405-nm optical system, laser driver 301 drives a laser diode 315 and laser diode 315 irradiates laser tight with a wavelength of 650 nm. A part of the laser light passes through a collimator lens 316, a beam splitter 317, and a condensing lens 318, the power being monitored in a power monitor 319. By feeding back the monitored power to controller 201, the intensity of the laser light collected in the guide layer of optical disc 102 is maintained at a desired power, such as e.g. 3 mW. The laser light transmitted through beam splitter 317 is transmitted through a polarizing beam splitter 320, the control of convergence/divergence and position being carried out in a relay lens 321. The laser light having passed through relay lens 321 is reflected in dichroic mirror 308. passes through quarter-wave plate 310 and is collected in the guide layer of optical disc 102 by means of objective lens 311. The laser light reflected in optical disc 102 is reflected in polarizing beam splitter 320 and is collected in a detector 323 with a condensing lens 322.

Relay lens error signal generation unit 217 generates, from the signal output from detector 323, a relay lens error signal which is an error signal for the focus direction and tracking direction with respect to the guide layer of optical disc 102. Relay lens control unit 218 generates a relay lens drive signal in response to the relay lens error signal by means of a command signal from controller 201. Relay lens drive unit 219 drives relay lens 321 in response to the relay lens drive signal and positions the laser spot on the guide layer.

Also, as for slider drive unit 205, aberration compensation drive unit 206, and spindle control unit 209 as well, there is operation by means of a command signal from controller 201.

Further, the same laser driver 301 was used here for driving laser diode 302 and laser diode 315, but it is also acceptable to provide individual laser drivers for the respective laser diodes. Also, spherical aberration compensation element 309 may be arranged in a position that has an influence on both the 405-nm optical system and the 650-nm optical system and may e.g. be arranged between quarter-wave plate 310 and dichroic mirror 308.

Next, there will be given a description regarding the tracking control. In the 405-nm optical system, tracking error signal generation unit 214 generates, from the signal output by detector 314, a tracking error signal with respect to a recording layer of optical disc 102. Also, in the 650-nm optical system, tracking error signal generation unit 214 generates, from the signal output from detector 323, a tracking error signal with respect to the guide layer of optical disc 102. Tracking control unit 215 selects a tracking error signal generated in the 405-nm optical system or the 650-nm optical system and generates a tracking drive signal corresponding to the error signal by means of a command signal from controller 201. Tracking drive unit 216 drives actuator 312 in the radial direction of the disc in response to the tracking drive signal. Further, since actuator 312 is jointly used by the 405-nm optical system and the 650-nm optical system, even in the case of controlling actuator 312 with a tracking error signal generated by one of the optical systems, the laser spot of the other optical system moves in a radial direction of optical disc 102.

Also, a relay lens drive signal corresponding to the error signal is generated from the command signal from controller 201 by relay lens control unit 218 by means of the tracking error signal generated by the 650-nm optical system. Relay lens drive unit 219 drives relay lens 321 in response to the relay lens drive signal to control the movement of the laser spot in a radial direction of the disc. In this case, the relay lens 321, since it is arranged in the 650-nm optical system, has the possibility of carrying out tracking control independently of the 405-nm optical system.

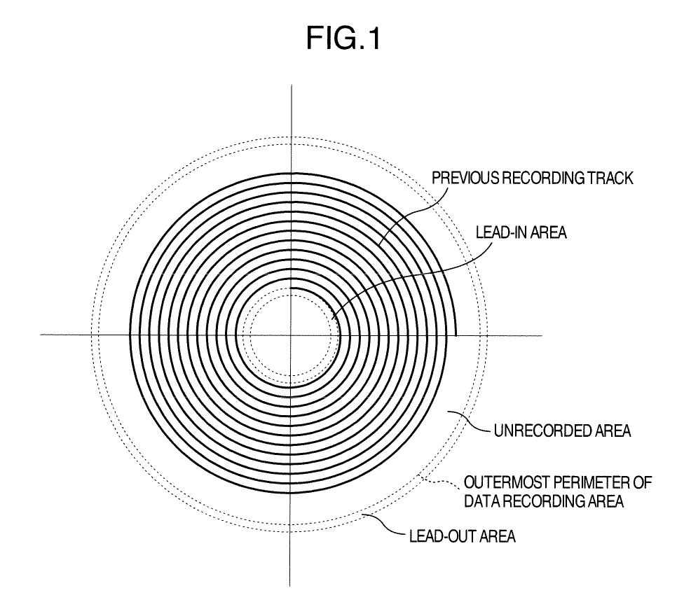

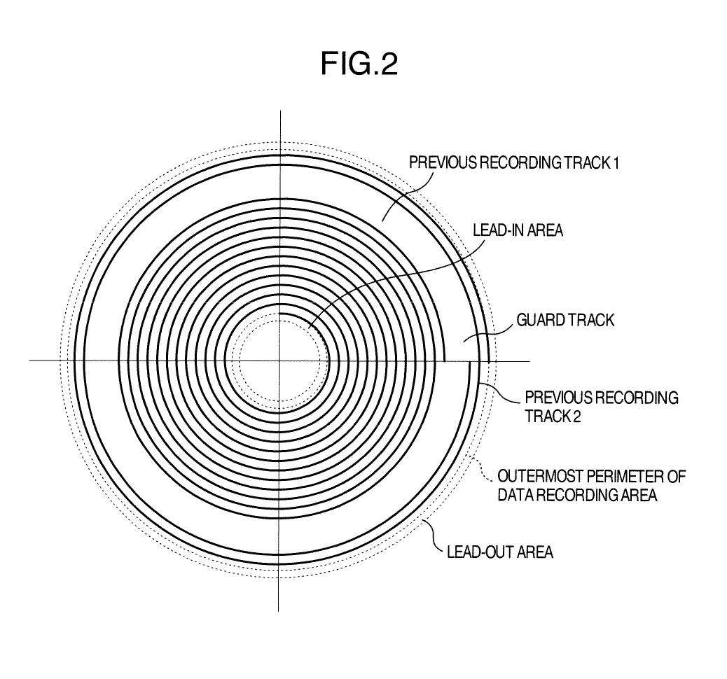

Next, a description will be given, by means of FIG. 1 regarding a method of recording information additionally, if there is an area which has once been recorded in a recording layer, from the recording end point thereof. FIG. 1 shows a recording track recorded in a recording layer of the disc. The recorded data are progressively recorded spirally from the inner perimeter toward the outer perimeter. The previously recorded data are recorded with a fixed pitch. The disc of FIG. 1 is in a state of not being recorded as far as the outermost perimeter of the data recording, with an unrecorded area coexisting. Further, the disc according to the present embodiment in which there exists an unrecorded area is a disc in which an unrecorded area is present in the data area, there being no assumption regarding unrecorded areas of lead-in and lead-out areas arranged before and after the data area. This state in which an additional recording has been made in the recording layer is shown in FIG. 2. Following a guard track provided after a previous recording track 1, a previous recording track 2 is additionally recorded as far as the outermost perimeter of the recording area This guard track is provided in order to prevent a recording track overwrite having as its cause the positional misalignment of the light spots of the guide layer and the recording layer that is due to a tilt of the disc. It is acceptable if the number of guard tracks at this point is sufficient to have a width that prevents overwriting, there being e.g. a method of taking into account the track pitch and computing the number of tracks from the disc tilt change from the state when a recording was made the previous time and the amount of light spot misalignment computed geometrically from the distance between the guide layer and the recording layer. Also, regarding the number of guard tracks, the embodiment is not limited to this method but may be set within the scope of preventing overwriting. In the case where the unrecorded areas after previous recording track I are few, the width of previous recording track 2 in the radial direction becomes narrow if a guard track is ensured, In the present invention, in order to accurately position the optical pickup with the slider motor in previous recording track 2, the conditions in the case of recording additionally in the previously recorded area are established and the radial direction width of previous recording track 2 is ensured to be sufficient. For this reason, in the case where it is not possible to generate sufficient width in previous recording track 2 to position the optical pickup at the time of making the additional recording, an additional recording in the concerned recording layer is taken to be impossible to implement, so it is prevented that a narrow recording area is generated.

It is judged by the following method whether an additional recording is carried out after previous recording track 1. In the case where the capacity of the unrecorded area after previous recording track 1 is equal to or less than the required capacity to generate a guard track, an additional recording is taken to be impossible to implement because the guard track cannot be generated.

Also, if the number of guard tracks is taken to be n, the track pitch is taken to be Tp, the amount of optical disc eccentricity is taken to be d, the recording capacity per unit recording width of a radial position in the proximity of the unrecorded area is taken to be A, and the recording capacity of the unrecorded area is taken to be R, in the case where

R<A×(n·Tp+d)

is satisfied, additional recording is taken to be impossible to implement even if the capacity of the unrecorded area is greater than the capacity required to generate a guard track, since the radial direction width of previous recording track 2 is narrow. E. g., when

R=A×(n·Tp+d),

even if the additional recording is carried out on all of the unrecorded area after the guard track, the width in the radial direction of a previous recording track 2 to be generated becomes d. Since the optical disc rotates having an eccentricity amount d, even if the optical pickup is fixed, the result is that the light spot on the optical disc, due to rotation, traverses previous recording track 2 from end to end. If, further, the width of previous recording track 2 becomes less than d. then there will necessarily arise, during rotation of the optical disc, a range in which the light spot will deviate from previous recording track 2. Accordingly, since it is not possible to ensure sufficient recording area width, it is taken to be impossible to implement an additional recording.

In addition, in the case where a stepping motor is used as the slider motor for optical pickup movements, if the movement quantity per pulse of the stepping motor is taken to be c, even in the case where

R<A×(n·Tp+d+c)

is satisfied, additional recording is taken to be impossible to implement, since the radial direction width of previous recording track 2 is narrow. Since the stepping motor rotates in a step-like manner by unit pulse, the movement of optical pickup also becomes step-like. Because of this, in the case of using a stepping motor, the accuracy of positioning is insufficient with a previous recording track 2 width of d, so a width of (d+c) taking into account the movement quantity c per pulse becomes necessary. As for the aforementioned eccentricity amount d, there may be used a value actually measured for each optical disc, but if the maximum allowable value of the specification value defined in the concerned optical disc system is used, handling with respect to eccentricity can be effectuated easily. Further, in the case where it is impossible to implement recording onto the concerned recording layer, and in the case where there is a recording area that can be recorded in another recording layer, recording may be continued in the other layer.

Further, the present invention is not one limited to the aforementioned embodiment, different variations being included therein. E.g., the aforementioned embodiment is one described in detail to explain the present invention in an easily comprehensible way, but it is not necessarily one comprising the entire described configuration.

1. An optical disc device carrying out data recording or playback with respect to an optical disc formed by being provided with a guide layer having a physical groove structure for carrying out tracking servo control and stacking recording layers carrying out recording and playback, comprising:
a first optical system which focuses a light beam on the guide layer and detecting the reflected light therefrom; and
a second optical system which focuses a light beam on the recording layers and detecting reflected light therefrom,
there being, in any of the recording layers, a recorded area in which recording of the data has been completed and an unrecorded area in which data have not yet been recorded; and that, in the case where the recording capacity of the unrecorded area is equal to or greater than a prescribed threshold value, takes additional data recording by means of the second optical system to be possible to implement, and when the recording capacity of the unrecorded area is less than the prescribed threshold value, takes additional data recording with respect to the recording layer to be impossible to implement.

2. The optical disc device according to claim 1, wherein,
on the occasion of carrying out a judgment on the implementation of additionally recording data after the recorded area, implementation of additional data recording with respect to the recording layer, with a method of providing a guard track and additionally recording the data, is taken to be impossible when the recording capacity of the unrecorded area is less than the recording capacity necessary for the generation of a guard track.

3. The optical disc device according to claim 1, wherein,
if the number of guard tracks is taken to be n, the track pitch is taken to be Tp, the amount of optical disc eccentricity is taken to be d, the recording capacity per unit recording width of a radial position in the proximity of the unrecorded area is taken to be A, and the recording capacity of the unrecorded area is taken to be R; and implementation of additional data recording with respect to the recording layer, with a method of providing a guard track and recording additionally, is taken to be impossible on the occasion of carrying out a judgment on the implementation of additionally recording data after the recorded area, in the case where
R<A×(n·Tp+d)
is satisfied.

4. The optical disc device according to claim 1, further comprising a stepping motor moving the first optical system and second optical system in a radial direction of the optical disc,
wherein the movement quantity per pulse of the stepping motor is taken to be c and,
if the number of guard tracks is taken to be n, the track pitch is taken to be Tp, the amount of optical disc eccentricity is taken to be d, the recording capacity per unit recording width of a radial position in the proximity of the unrecorded area is taken to be A, and the recording capacity of the unrecorded area is taken to be R, implementation of additional data recording with respect to the recording layer, with a method of providing a guard track and recording additionally, is taken to be impossible on the occasion of carrying out a judgment on the implementation of additionally recording data after the recorded area, in the case where
R<A×(n·Tp+d+c)
is satisfied.

5. The optical disc device according to claim 3, wherein the amount of eccentricity d is taken to be the maximum allowable eccentricity value defined in the specification of the optical disc system.

6. The optical disc device according to claim 1, wherein, in the case where an additional data recording in the unrecorded area of the recording layer is impossible to implement and in the case where there is a recordable unrecorded area in another recording layer, data recording is continued with respect to the other recording layer.

7. An optical disc device recording method carrying out data recording with respect to an optical disc formed by being provided with a guide layer having a physical groove structure for carrying out tracking servo control and stacking recording layers carrying out recording and playback,
wherein the optical disc device has a first optical system focusing a light beam on the guide layer and detecting the reflected light therefrom and a second optical system focusing a light beam on the recording layers and detecting reflected light therefrom,
there being, in any of the recording layers, a recorded area in which recording of the data has been completed and an unrecorded area in which data have not yet been recorded, and, in the case where the recording capacity of the unrecorded area is equal to or greater than a prescribed threshold value, takes additional data recording by means of the second optical system to be possible to implement, and when the recording capacity of the unrecorded area is less than the prescribed threshold value, takes additional data recording with respect to the recording layer to be impossible to implement.

8. The recording method according to claim 7, wherein, on the occasion of carrying out a judgment on the implementation of additionally recording data after the recorded area, implementation of additional data recording with respect to the recording layer, with a method of providing a guard track and additionally recording the data, is taken to be impossible when the recording capacity of the unrecorded area is less than the recording capacity necessary for the generation of the guard track.

9. The recording method according to claim 7, wherein, if the number of guard tracks is taken to be n, the track pitch is taken to be Tp, the amount of optical disc eccentricity taken to be d, the recording capacity per unit recording width of a radial position in the proximity of the unrecorded area is taken to be A, and the recording capacity of the unrecorded area is taken to be R; and implementation of additional data recording with respect to the recording layer, with a method of providing a guard track and recording additionally, is taken to be impossible on the occasion of carrying out a judgment on the implementation of additionally recording data after the recorded area, in the case where
R<A×(n·Tp+d)
is satisfied.

10. The recording method according to claim 7, wherein the optical disc device has a stepping motor moving the first optical system and second optical system in a radial direction of the optical disc and the movement quantity per pulse of the stepping motor is taken to be c and,
if the number of guard tracks is taken to be n, the track pitch is taken to be Tp, the amount of optical disc eccentricity is taken to be d, the recording capacity per unit recording width of a radial position in the proximity of the unrecorded area is taken to be A, and the recording capacity of the unrecorded area is taken to be R; and implementation of additional data recording with respect to the recording layer, with a method of providing a guard track and recording additionally, is taken to be impossible on the occasion of carrying out a judgment on the implementation of additionally recording data after the recorded area, in the case where
R<A×(n·Tp+d+c)
is satisfied.

11. The recording method according to claim 9, wherein the amount of eccentricity d is taken to be the maximum allowable eccentricity value defined in the specification of the optical disc system.

12. The recording method according to claim 7, wherein, in the case where an additional data recording in the unrecorded area of the recording layer is impossible to implement and in the case where there is a recordable unrecorded area in another recording layer, data recording is continued with respect to the other recording layer.

13. The optical disc device according to claim 4, wherein the amount of eccentricity d is taken to be the maximum allowable eccentricity value defined in the specification of the optical disc system.

14. The recording method according to claim 10, wherein the amount of eccentricity d is taken to be the maximum allowable eccentricity value defined in the specification of the optical disc system.
